(19) United States
(12) Patent Application Publication
(10) Pub. No.: US 2025/0054405 A1
(43) Pub. Date: Feb. 13, 2025

(54) System for Providing Step-by-Step Explanations of Pedagogical Exercises Using Machine-Learned Models

(71) Applicant: Google LLC, Mountain View, CA (US)

(72) Inventors: Jessica Lee, Brooklyn, NY (US); Kimiya Hojjat, Oakland, CA (US); David Trotter Oleson, Zurich (CH); Daniel Valcarce Silva, Zurich (CH); Andrea D'olimpio, Zurich (CH); Urs Christian Lukas Dönni, Fehraltorf (CH); Christopher Rohrs, Mountain View, CA (US); Kuba Dolecki, Mountain View, CA (US); Balint Miklos, Zurich (CH); Federico Chialvo, Mountain View, CA (US); Lisa Wang, Mountain View, CA (US); Jieru Hu, Mountain View, CA (US); Ryan Muller, Mountain View, CA (US); Chris Heather, Mountain View, CA (US); Sara Wiltberger, Mountain View, CA (US); Saurabh Paliwal, Zurich (CH); Viacheslav Kuznetsov, Zurich (CH); Gleb Makarchuk, Zurich (CH); Philipp Neubeck, Zurich (CH); Ivan Jurin, Zagreb (HR)

(21) Appl. No.: 18/446,125

(22) Filed: Aug. 8, 2023

(51) Int. Cl. G09B 7/02; G06F 16/9535; G06F 16/9538; G06F 40/40

(52) U.S. Cl. CPC G09B 7/02; G06F 16/9535; G06F 16/9538; G06F 40/40

(57) ABSTRACT

The present disclosure provides computer-implemented methods, systems, and devices for generating multistep explanations for pedagogical exercises. A computing device receives a query from a user. The computing device determines that the query includes query data describing a pedagogical exercise to be solved. The computing device provides the query data as input to an explanatory machine-learned model. The computing device receives, as output from the explanatory machine-learned model, a pedagogical response, the pedagogical response including a multi-step explanation of a solution to the pedagogical exercise. The computing device provides the pedagogical response for display to a user.

### FIELD

The present disclosure relates generally to providing explanations for pedagogical exercises. More particularly, the present disclosure relates to using machine learning models to provide multi-step explanations for solving pedagogical exercises.

### BACKGROUND

Improvements in technology have enabled a variety of different services to be provided to users. For example, search services can respond to general user queries quickly and efficiently. However, for specific types of queries, a general search system may not provide the most optimal response.

For example, it can be tedious and time-consuming for a user to search for the specific information that will help the user solve the homework problem. Additionally, the user may find explanations that are not appropriate for their current level of understanding. As a result, users may find the process of using search engines to assist in working on homework problems so difficult that they cease to use search engines while working on these homework problems.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include receiving a query from a user. The operations can include determining that the query includes query data describing a pedagogical exercise to be solved. The operations can further include providing the query data as input to an explanatory machine-learned model. The operations can further include receiving, as output from the explanatory machine-learned model, a pedagogical response, the pedagogical response including a multi-step explanation of a solution to the pedagogical exercise. The operations can further include providing the pedagogical response for display to a user.

Another example aspect of the present disclosure is directed to a computer-implemented method. The method can include receiving, by a computing system comprising one or more processors, an image that includes a pedagogical exercise. The method can further include extracting, by the computing system, data describing the pedagogical exercise. The method can further include providing, by the computing system, the data describing the pedagogical exercise as input to an explanatory machine-learned model. The method can further include receiving, as output from the explanatory machine-learned model, a pedagogical response, the pedagogical response including a multi-step explanation of the solution to the pedagogical exercise. The method can further include providing the pedagogical response for display to a user.

Another example aspect of the present disclosure is directed to one or more non-transitory computer-readable media that collectively store instructions that, when executed by one or more computing devices, cause the one or more computing devices to perform operations. The operations can include obtaining first training data for a large language model, wherein the training data includes a plurality of example pedagogical exercises, the solutions to those exercises, and ground truth multi-step explanations for the solutions. The operations further include providing the pedagogical exercises and the solutions to those exercises as input to a synthesis machine-learned model. The operations further include receiving, as output from the synthesis machine-learned model, a first plurality of multi-step solutions for pedagogical exercises. The operations further include comparing evaluating the plurality of multi-step solutions to the ground truth multi-step explanations and updating one or more characteristics of the synthesis machine-learned model based on the comparison until the plurality of multi-step solutions meet one or more criteria of acceptability. The operations further include obtaining second training data, wherein the second training data includes a plurality of example pedagogical exercises and the solutions to those exercises without multi-step explanations. The operations further include providing the second training data as input to the synthesis machine-learned model. The operations further include receiving, as output from the synthesis machine-learned model, a second plurality of multi-step solutions for the pedagogical exercises included in the second training data. The operations further include training an explanatory machine-learned model using the second training data and the second plurality of multi-step solutions generated by the synthesis machine-learned model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that generates multi-step solutions for pedagogical exercises according to example embodiments of the present disclosure.

FIG. 2A depicts an illustration of an example interface for accepting queries associated with a pedagogical exercise and displaying multi-step solutions to the pedagogical exercise according to example embodiments of the present disclosure.

FIG. 2B depicts an illustration of an example interface for accepting queries associated with a pedagogical exercise and displaying multi-step solutions to the pedagogical exercises according to example embodiments of the present disclosure.

FIG. 2C depicts an illustration of an example interface for accepting queries associated with a pedagogical exercise and displaying multi-step solutions to the pedagogical exercise according to example embodiments of the present disclosure.

FIG. 3A depicts an illustration of an example interface for accepting queries associated with a pedagogical exercise and displaying multi-step solutions to those pedagogical exercises according to example embodiments of the present disclosure.

FIG. 3B includes an example interface that can display a multi-step explanation to the user in response to the user requesting that explanation through the explanation request interface element in accordance with example embodiments of the present disclosure.

FIG. 4 represents an example system for providing multi-step explanations to pedagogical exercise according to example embodiments of the present disclosure.

FIG. 5 depicts a block diagram of an example computing device that performs according to example embodiments of the present disclosure.

FIG. 6 depicts a block diagram of an example computing device that performs according to example embodiments of the present disclosure.

FIG. 7 depicts an example flow diagram for a method of generating additional training data using a synthesis machine-learned model according to example embodiments of the present disclosure.

FIG. 8 depicts an example flow diagram for a method of generating multi-step explanation of solutions for pedagogical exercises according to example embodiments of the present disclosure.

Reference numerals that are repeated across plural figures are intended to identify the same features in various implementations.

### DETAILED DESCRIPTION

Generally, the present disclosure is directed to systems and methods for providing multi-step explanations for pedagogical exercises using machine-learned models. In particular, the systems and methods disclosed herein can provide information for assisting learners of a subject by providing in-depth multi-step explanations of solutions to pedagogical exercises. In some examples, the pedagogical exercises can be submitted by a user as a search query or other specific user request. The system can analyze the request to determine whether it includes a pedagogical exercise for which a multi-step solution would be useful. If the pedagogical response system determines that the query includes a pedagogical exercise, the pedagogical response system can generate input to an explanation model (e.g., a machine-learned large language model trained to provide explanations for solving pedagogical exercises). The input can be a prompt that includes data describing the pedagogical exercise as well as context data that can be used to generate a useful explanation for the requesting user.

An explanatory machine-learned model (e.g., a large language model) can be trained to provide multi-step explanations for specific pedagogical exercises. Thus, when the explanatory machine-learned model receives input that includes a pedagogical exercise, the output generated by the explanatory machine-learned model can include a plurality of instructions explaining how to solve the pedagogical exercise. Specifically, each instruction can be a step in a multi-step process of solving the problem described in detail. The output can be displayed to a user. In some examples, the output of the explanatory machine-learned model can be formatted such that each step in the multiple steps can be displayed in a distinct section of the user interface. In some examples, each distinct section of the user interface (in which a single step from the multi-step solution is displayed) can be collapsible and expandable. In this way, a user can choose which steps are displayed in detail. Doing so results in more efficient use of interface space.

In some examples, training the explanatory machine-learned model to provide a multi-step explanation can be difficult due to the lack of a sufficient number of examples of appropriate multi-step explanations. In order to overcome this problem, a synthesis machine-learned model can be trained to convert existing solutions into multi-step explanations. This synthesis machine-learned model can use a relatively small set of training examples that include a pedagogical exercise, a solution, and an associated multi-step solution as ground truth data. The pedagogical response system can use this training data to train the synthesis machine-learned model to convert an existing problem solution pair into a multi-step explanation. Once the synthesis machine-learned model has been trained to generate multi-step explanations from a problem-solution pair, the system can access a much larger corpus of pedagogical exercises with existing solutions but without existing multi-step explanations.

The synthesis machine-learned model can be trained to generate a satisfactory multi-step explanation for each pedagogical exercise in the large corpus. These examples can be used as training data to train the explanatory machine-learned model and improve its ability to output useful and satisfactory multi-step explanations for pedagogical exercises for which no existing solution is provided. Once sufficient training data has been generated by the synthesis machine-learned model and the explanatory machine-learned model has been trained using that training data, the explanatory machine-learned model can be used to provide multi-step explanations for any pedagogical exercise submitted in a query for a user.

For example, if a user submits a query that includes the text “calculate the area under the curve defined by x²+2x+8 from zero to eight,” the pedagogical response system can generate a prompt for the explanatory machine-learned model that includes the pedagogical exercise as well as any other contextual information that is available. The prompt, including data describing the pedagogical exercise, can be provided to the explanatory machine-learned model. The explanatory machine-learned model can generate a pedagogical response as output. The pedagogical response can be a multi-step solution to the pedagogical exercise. For example, the explanatory machine-learned model can generate a multi-step solution that includes five steps. The five steps can be presented to the user in a user interface. Each step can be presented in a distinct collapsible element in the interface. When a particular element is collapsed, the interface may only display a brief explanation of that step. When the collapsible element is expanded, the interface can include an in-depth explanation of how the step is performed. In this way, users can leave familiar steps collapsed and expand the sections associated with steps they do not understand. The more in-depth explanation can include text, images, and/or rendered equations.

More generally, a pedagogical response system can be enabled by an application on a user computing device, by communicating with a remote server system, or a combination of both. A server computing system can be any computing system configured to communicate with a user computing device (or other computing devices) over a network to provide information or a service. If a server computing system is employed, the server computing system can receive, from a user computing device, queries, requests, image data, and so on provided by the user computing device through an application.

A user computing device can be any computing device that is designed to be operated by an end-user. For example, a user computing device can include but is not limited to a personal computer, a smartphone, a smartwatch, a fitness band, a tablet computer, a laptop computer, a hand-held navigation computing device, a wearable computing device, a game console, and so on. In some examples, a user computing device can include one or more sensors intended to gather information, with the permission of the user, such as an image sensor (e.g., a camera).

In some examples, a pedagogical response system can receive a request from a user. The request can be received in a variety of formats. In some examples, the request can be received as a search query (or a portion of a search query). If the search system receives a search query, the search service can analyze the search query to determine whether it includes a pedagogical exercise. For example, a user may type a particular pedagogical exercise into a search input field associated with a search application or a search website. The search service can analyze the entered text and, if a pedagogical exercise is detected, utilize a pedagogical response system to provide an appropriate response. As used herein, a pedagogical exercise can be a problem associated with homework or the general learning of any topic. However, the pedagogical response system can be associated with any procedural problem (e.g., any problem that can be explained using a step-by-step solution.) Thus, pedagogical exercise can be any problem that a user may have that can be explained as a series of steps. For example, simple home repairs can be presented as a series of steps to be performed. Similarly, tasks such as calculating a tip on a bill or planning a garden fence can be included in the scope of a pedagogical exercise.

In some examples, the pedagogical exercise can be received via an image analysis system. For example, an application can provide live interaction with video captured by the user computing device. The user computing device can, while the live video is being presented to the user, analyze the contents of that video. In some examples, the application can determine that the displayed video includes a pedagogical exercise. If so, the interface can be updated with an element (e.g., a button) that a user can select to request an explanation of the displayed pedagogical exercise. If the user selects the button, the application can extract data associated with the pedagogical exercise and provide it as input to a pedagogical response system.

In another example, a pedagogical response application can be provided to the user. In this case, the user accesses the application with the specific intent of requesting an explanation of a pedagogical exercise. The user can scan a problem from a textbook or type the exercise into a prompt area and the application will automatically generate a pedagogical response using an explanatory machine-learned model.

In some examples, the one or more machine-learned models can be any of a variety of various machine-learned models such as neural networks (e.g., deep neural networks or large language models), other types of machine-learned models, including non-linear models and/or linear models, or binary classifiers. Neural networks can include feed-forward neural networks, recurrent neural networks (e.g., long short-term memory recurrent neural networks), convolutional neural networks, Transformer networks, denoising diffusion models, or other forms of neural networks.

In some examples, more than one machine-learned model can be used to provide the most useful pedagogical responses. An explanatory machine-learned model can be a model that generates multi-step explanations. This machine-learned model can be a large language model. It is referred to as an explanatory model for the purpose of distinguishing it from other machine-learned models that may be used as part of the training process. The explanatory machine-learned model takes a pedagogical exercise as input and outputs a multi-step explanation of a solution to the input pedagogical exercise.

In some examples, training the explanatory machine-learned model can be difficult due to the need for training examples of multi-step explanations to pedagogical exercises. While many different pedagogical exercises are publicly available along with solutions, very few of the available solutions are multi-step explanations of the kind generated by the explanatory machine-learned model. To access a sufficient amount of training data to successfully train the explanatory model, a synthesis machine-learned model can be used to convert solutions for available pedagogical exercises into multi-step explanations in the desired format. The synthesis machine-learned model can be initially trained using a relatively small number of pedagogical exercises along with corresponding solutions and multi-step explanations. This small number of pedagogical exercises with corresponding solutions and multi-steps explanations can be manually created (or vetted) by users as an initial starting point. This data can be used as ground truth data. The synthesis machine-learned model can be trained to take the pedagogical exercises and their solutions as input and output multi-step explanations of those solutions. Ground truth data with existing multi-step solutions can be provided to improve the accuracy of the synthesis machine-learned model such that it generates accurate multi-step explanations for pedagogical exercises with a solution that is already known.

In some examples, the synthesis machine-learned model can be trained in a variety of different ways. For example, the training set can include a plurality of pedagogical exercises that do not have associated solutions or multi-step explanations. In this case, the output from the synthesis machine-learned model can be evaluated or corrected by humans. The corrected explanations can be fed back into the synthesis machine-learned model. In another example, the training sets can include pedagogical exercises with associated solutions and the output of the synthesis machine-learned model can be evaluated against the known solution to improve the output of the synthesis machine-learned model.

The synthesis machine-learned model can, once trained, be used to take a large corpus of pedagogical exercises and solutions which are available and generate multi-step explanations for them. These newly generated multi-step explanations can be used, along with their corresponding pedagogical exercise descriptions, as input to train the explanatory machine-learned model. Thus, the synthesis machine-learned model is used to generate a corpus of training data that can be used to train the explanatory machine-trained model.

In some examples, additional machine-learned models can also be used. For example, an image generation machine-learned model can be used to generate appropriate images as needed by the explanatory machine-learned model. The explanatory machine-learned model can output a series of steps to solve a problem. Each step may include detailed explanations for what to display in the user interface to the user including text, images, mathematical formulas, and the layout/formatting to be used when displaying the multi-step explanation. In some examples, the output of the explanatory machine-learned model can include a text description of what the image should contain. This description can be provided to an image generation machine-learned model that can then generate an appropriate image for the corresponding step.

Similarly, the output of the explanatory model can include information needed to render a mathematical formula (e.g., “rendering code”). This rendering data can be provided to a rendered image and the appropriate mathematical model can be rendered so it can be displayed to the user as needed. For example, a renderer can execute the rendering code to render the mathematical formula. In this way, the multi-step explanations can be multi-modal without the explanatory model being capable of generating images and rendering formulas itself.

The pedagogical response system can provide input to the explanation model. In some examples, the input to a machine-learned model, especially if it is a large language model, takes the form of a prompt. The prompt is a specific request of the large language model and sets the parameters for the response the large language model will give to the prompt. In some examples, the prompt can include the pedagogical exercise for which a solution has been requested. The pedagogical exercise can consist of text, images, or can include audio provided by the user. In some examples, the pedagogical exercise can also include one or more mathematical formulas.

Contextual information can also include similar pedagogical exercises previously received by the explanatory machine-learned model. This can include both the query from which the Pedagogical exercise was extracted, the generated prompt, and the output produced by the explanatory machine-learned model. In some examples, the pedagogical response system can also perform a search of the web (or other store of data) and provide the results as context in a prompt.

In addition to the pedagogical exercise to be solved, the prompt can also include contextual information. Contextual information can include information about the user that the user has agreed to provide as part of receiving the appropriate explanation to the pedagogical exercise. For example, the prompt can include the current understanding level of the user. For example, a user with a very basic understanding of a topic may receive a more in-depth explanation of particular steps than would be required for a user who has a more significant understanding of the subject.

The prompt can also include topic-specific information associated with the pedagogical exercise. For example, if the pedagogical exercise is associated with a particular topic, the pedagogical response system can retrieve information about that topic from a pedagogical database and provide it to the explanation model as part of the input (e.g., as additional “context” input). In some cases, providing additional background information can be useful in ensuring that the response provided by the explanatory machine-learned model is as accurate as possible.

In some examples, the request associated with a particular pedagogical exercise can be part of an ongoing conversation with a user. For example, the user could ask a series of questions related to one or more different pedagogical exercises. The prompt can include the past conversation history or background associated with any particular request. In some examples, the user may ask a clarifying question about a previously presented explanation. This original explanation can be provided as context for the clarification question.

In some examples, the explanatory machine-learned model will provide an output in response to the input. The output, based at least in part on the prompt, can be a multi-step explanation of how to solve the particular pedagogical exercise. A multi-step explanation is an explanation that includes a plurality of steps that need to be followed to reach a solution. The output can also be called a pedagogical response.

In some examples, the output generated by the explanatory machine-learned model can be specific to a particular user. For example, the multi-step explanation can be tailored to the user's current understanding or the user's needs. To do so, information included in a user profile (e.g., information about the users current understanding or mastery level for a topic) can be provided as context for the prompt and the explanatory machine-learned model can generate a multi-step explanation that is directed towards the current level of the user. The output data can be formatted such that each step in the multi-step process is displayed in a particular portion of the user interface. As discussed above, each step can include text, images, and mathematical formulas. The mathematical formulas can be rendered based on information output by the explanatory machine-learned model.

In some examples, the steps are displayed in separate sections of the interface based on formatting data (e.g., markup data) included in the output or otherwise provided by the explanatory machine-learned model. In some examples, each section can be collapsible. In this way, the collapsed version of a step may include a basic statement of what the step is. The user can then select an interface element that causes the section to expand. The expanded section can display a significantly more detailed version of that step. In this way users can determine which steps they want to view in detail and which steps can be represented by a brief summary (e.g., the user only expands steps they are not already familiar with). Collapsible sections allow a user to decide which steps are displayed in detail, resulting in an easier to understand and less crowded user interface.

In some examples, the output of the explanatory machine-learned model designates one or more of the steps as being initially collapsed and one or more of the steps as initially expanded. In some examples, the explanatory machine-learned model can designate particular steps as being expanded or collapsed based on information about the current level of understanding that the user currently has (e.g., context data input into the explanatory machine-learned model in a prompt). Thus, for some advanced users, the explanatory machine-learned model may only designate the complicated steps to be expanded and designate the simple steps to be collapsed. In contrast, when generating a response for a beginning user, the explanatory machine-learned model may determine that the first step should be expanded with the expectation the user will expand each step as they go through.

In other examples, one or more steps are initially expanded based on their position in the step order (e.g., the first step is always expanded) or the difficulty of the content in a particular step (e.g., the most difficult steps are expanded and simpler steps default to being collapsed).

Once the output is provided by the explanation machine-learned model, the output can be displayed to a user. In some examples, if the explanatory machine-learned model is provided at a server computing system, the data will be transmitted via computing network to the user computing device. In other examples, the explanatory machine-learned model is being executed by the user computing device and does not need to be transmitted via network.

In some examples, the output of the explanatory model includes a confidence value, the confidence value representing the degree to which explanatory model is confident in the validity of the generated multi-step explanation. In some examples, if the confidence value is above a predetermined threshold, the explanation can be displayed as normal. However, if the confidence value is below the threshold, the response system give a less detailed explanation (a hint) that avoids factual inaccuracies.

For example, if the pedagogical exercise is “over what interval is the function f(x)=x3−4x−3 decreasing”? The explanatory machine-learned model can determine that the proposed response may not be reliable based on a confidence value. Instead of displaying an explanation with a low confidence value, the response system can display a briefer answer, such as “I'm not sure how to solve this, but I think you need to find the interval of x values for which the first derivative of the function is negative”. In this way, the user can determine whether the explanation is sufficient and, if not, provide more detail to the system.

The systems and methods of the present disclosure provide a number of technical effects and benefits. As one example, the system and methods can provide real-time, personalized explanations for any pedagogical exercise that is submitted to the system. In particular, the systems and methods disclosed herein can receive a query, determine that the query includes or is associate with a pedagogical exercise, generate input to an explanatory model, and receive, from the explanatory machine-learned model, a structured multi-step explanation of the solution to the pedagogical exercise for display to the requesting user.

The disclosed system can analyze queries or requests to determine whether a pedagogical exercise is present. Initially classifying the query or request in this way allows the system to refrain from using the explanatory machine-learned model when not needed. This results in the technical benefit of reducing the power and memory use of the system while simultaneously providing a better user experience.

Furthermore, providing structured, multi-step explanations allows users to selectively decide what portions of the explanation to review in detail. Doing so reduces clutter in a display, while simultaneously reducing the amount of memory used and bandwidth required by only transmitting detail when requested by the user.

Additionally, and/or alternatively, the systems and methods can provide personalized explanations for any possible pedagogical exercise. Providing personalized, structured multi-step explanations to any pedagogical exercise greatly improves the user experience for a query system, while maintaining relatively low cost for generating explanations and storing the data needed to generate the solutions. Doing so reduces the power consumption for generating solutions and storing data.

Thus, aspects of the proposed systems and methods represent a technical solution to the technical problem of insufficient training data. In particular, machine learning models require substantial and specific training data to function effectively. However, there's a scarcity of multi-step explanations for pedagogical exercises. This system introduces a novel way of generating such data using a synthesis initial machine-learned model that converts existing solutions into multi-step explanations. Thus, it solves the problem of limited training data for the model.

Aspects of the proposed systems and methods also represent a technical solution to the technical problem of efficient usage of computational resources. The proposed system can determine whether a user query includes a pedagogical exercise before engaging the explanatory machine-learned model. This selective engagement of the model helps optimize computational resources by only employing the model when necessary, addressing the issue of unnecessary computational load.

Aspects of the proposed systems and methods also represent a technical solution to the technical problem of data efficiency and bandwidth utilization. The system can generate structured multi-step explanations that users can selectively expand for further details. This interactive, demand-based information delivery reduces the amount of data transmitted across the network, addressing the problem of high bandwidth usage and data inefficiency.

Aspects of the proposed systems and methods also represent a technical solution to the technical problem of integrating multi-modal content. The system can generate explanations that include text, images, and mathematical formulas. However, generating images or rendering mathematical formulas could be computationally heavy tasks. The system addresses this problem by using separate models or renderers to handle these tasks, optimizing the computational process.

With reference now to the Figures, example embodiments of the present disclosure will be discussed in further detail.

### Example Devices and Systems

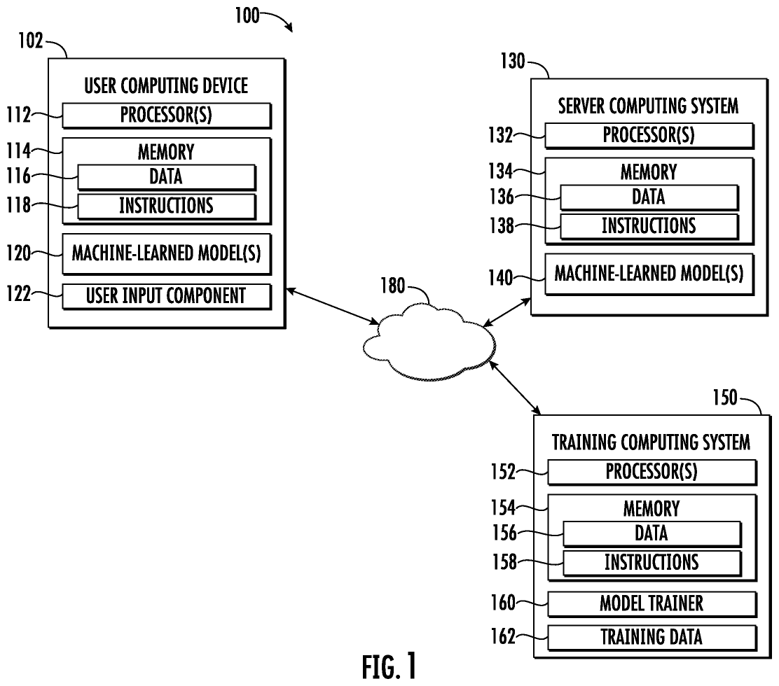

FIG. 1 depicts a block diagram of an example computing system 100 that generates multi-step solutions for pedagogical exercises according to example embodiments of the present disclosure. The computing system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

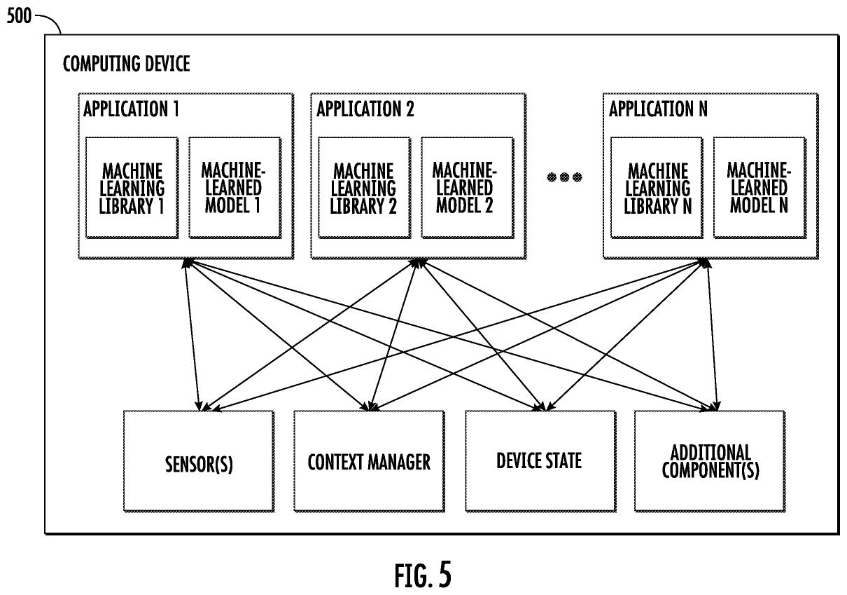

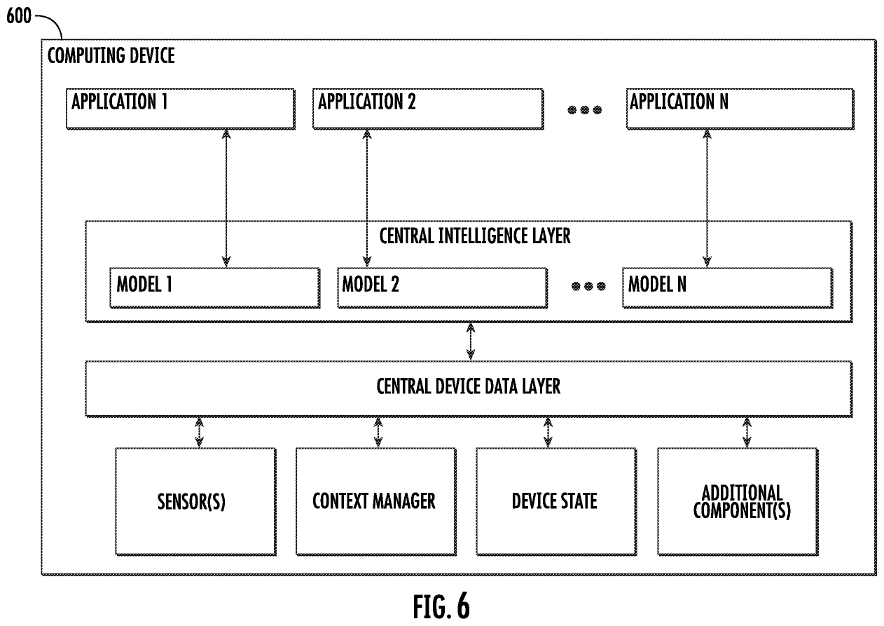

In some implementations, the user computing device 102 can store or include one or more machine-learned models 120 (e.g., one or more machine-learned explanatory models). For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIGS. 5-6.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

More particularly, the machine-learned model (e.g., an explanatory model and/or a synthesis model) can receive a pedagogical exercise as input as part of a query or a request. The machine-learned model (e.g., the explanatory model and/or a synthesis model) can generate a structured, multi-step explanation describing the steps to take to solve the pedagogical exercise. The structured multi-step explanation can be displayed to a user in an interface (e.g., a user interface at the user computing device of the requesting user). Each step in the structured multi-step solution can include text, images, mathematical formulas, and so on. In addition, the interface can display each step in a collapsible display element. When collapsed, the element may include only a basic description of the step. When expanded, the element can include a detailed description of how to accomplish the step as well as specific information about how the step is applied in the particular pedagogical exercise for which an explanation was requested.

Additionally, or alternatively, one or more machine-learned models 140 (e.g., one or more explanatory models and/or synthesis models) can be included in or otherwise stored and implemented by the server computing system 130 that communicates with the user computing device 102 according to a client-server relationship. For example, the one or more machine-learned models 140 can be implemented by the server computing system 130 as a portion of a web service (e.g., as part of a query response service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140 (e.g., one or more explanatory models and/or synthesis models). For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 5-6.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the explanation models 120 and/or 140 based on a set of training data 162. The training data 162 can include, for example, example pedagogical exercise with accompanying structured, multi-step explanations (or other ground truth data), training context data, and/or training motion data.

In some examples, the training data 162 is itself generated by a synthesis machine-learned model. The synthesis machine-learned model can be trained to generate multi-step explanations for specific pedagogical exercises that have associated solutions already. The synthesis machine-learned model can therefore use the exercises themselves, and their solutions to generate multi-step solutions for those exercises. Once the synthesis machine-learned model is trained to provide the multi-step explanations accurately, the synthesis machine-learned model can generate additional training exercises for the training data 162 based on any pedagogical exercise that has an associated solution whether that solution is a multi-step explanation or not. Given the fact that there are a large number of pedagogical exercises with solutions available, the amount of training data that can be used to train the explanatory machine-learned model 120 and/or 140 is greatly increased.

In some implementations, if the user has provided consent, the training examples can be provided by the user computing device 102. Thus, in such implementations, the machine-learned model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP. HTTP. SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be image data. The machine-learned model(s) can process the image data to generate an output. As an example, the machine-learned model(s) can process the image data to generate a multi-step explanation by extracting a pedagogical exercise from the image.

In some implementations, the input to the machine-learned model(s) of the present disclosure can be text or natural language data. The machine-learned model(s) can process the text or natural language data to generate an output. As an example, the machine-learned model(s) can process the natural language data to determine whether the text or natural language data includes a pedagogical exercise and, if so, generate a multimodal multi-step explanation as output.

In some implementations, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the explanatory model.

FIG. 1 illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

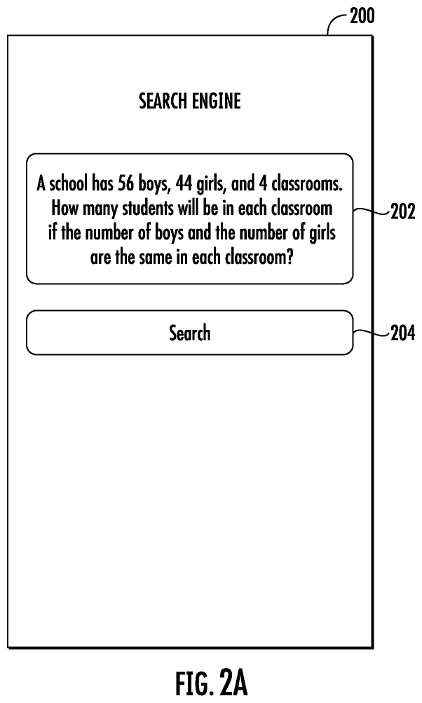

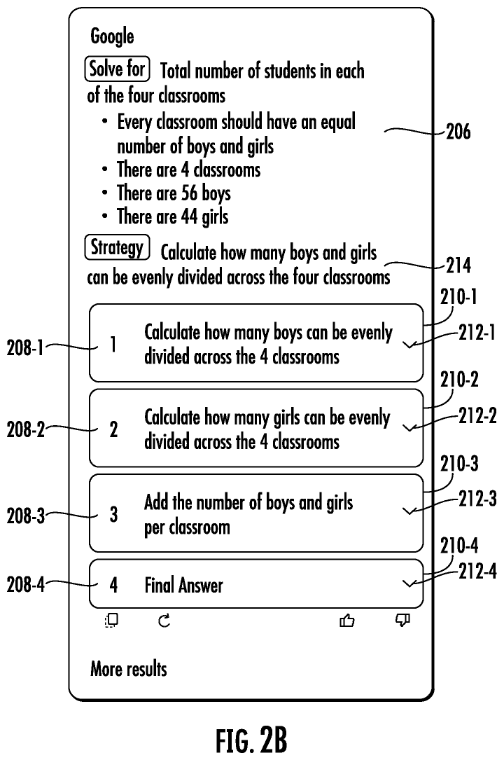

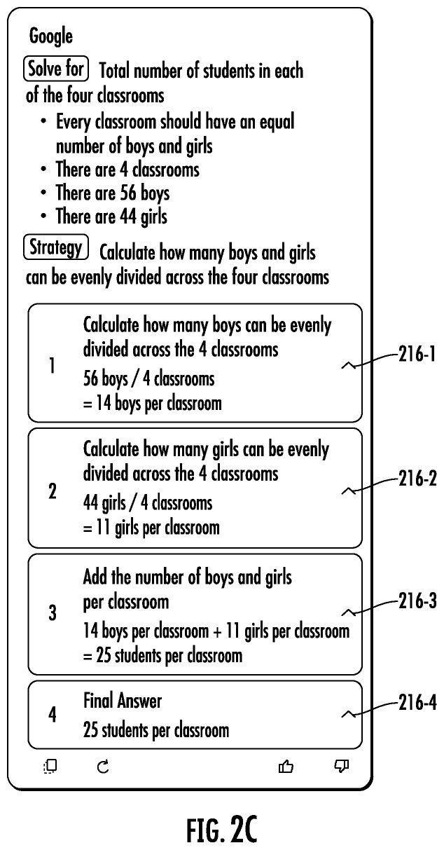

FIG. 2A depicts an illustration of an example interface for accepting queries associated with a pedagogical exercise and displaying multi-step explanations to the pedagogical exercise according to example embodiments of the present disclosure. In some implementations, the pedagogical response system can include one or more machine-learned models (e.g., explanatory machine-learned models or synthesis machine-learned model) trained to generate multi-step explanations for solving a pedagogical exercise provided as input.

In order to receive the pedagogical exercise, the user can input information describing the pedagogical exercise into a query field 202 on a website or application 200 associated with providing responses to user queries. The text of the query can be input into input field 202, and the service or application 200 associated with providing responses to queries to analyze the input query to determine whether it is a pedagogical exercise. In some examples, the user interface of the website or application 200 can include a user interface element 204 for submitting the query or request.

In some examples, the query response system can determine that the input query is associated with the pedagogical exercise. In this case, the query response system can provide the text of the query or a processed version of the text of the query to the pedagogical response system.

FIG. 2B depicts an illustration of an example interface for displaying the output of an explanatory machine-learned model according to example embodiments of the present disclosure. The pedagogical response system can generate input to an explanation machine-learned model (e.g., a large language model trained to provide multi-step solutions to pedagogical exercises). The model can output a multi-step explanation of the solution to the pedagogical exercise. In this example the interface can display the pedagogical exercise 206, a high-level strategy for solving the pedagogical exercise 214, and one or more steps for solving the exercise (e.g., 208-1 to 208-4).

Each step in the multi-step system can be displayed in a distinct collapsible section (e.g., 210-1 to 210-4). Each respective section can have an interface element for expanding or collapsing the respective section. In this example, the element is a downward facing caret when the section is collapsed (212-1 to 212-4). In a collapse state, each section can provide a brief synopsis of the step.

FIG. 2C depicts an illustration of an example interface for displaying the output of an explanatory machine-learned model with the steps displayed in expanded form according to example embodiments of the present disclosure. When each step is expanded, more detailed information about how to perform this step can be provided. The expanded sections can also include a user interface element to collapse the section again, in this case an upward facing caret (216-1 to 216-4). In some examples, the answer for pedagogical exercise is one of the steps.

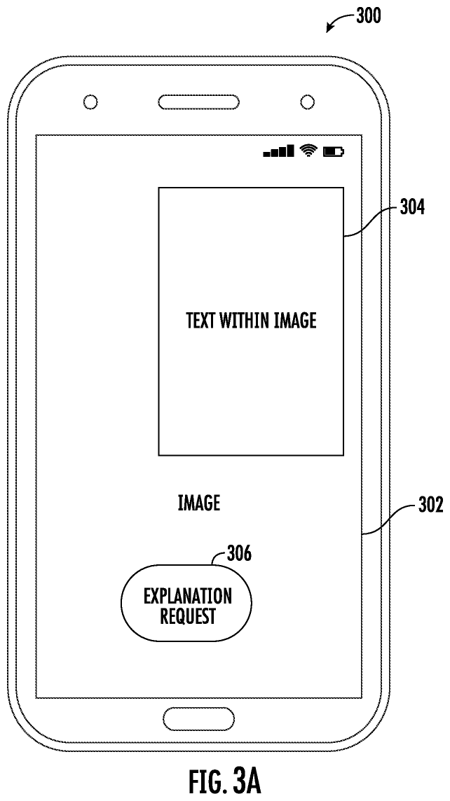

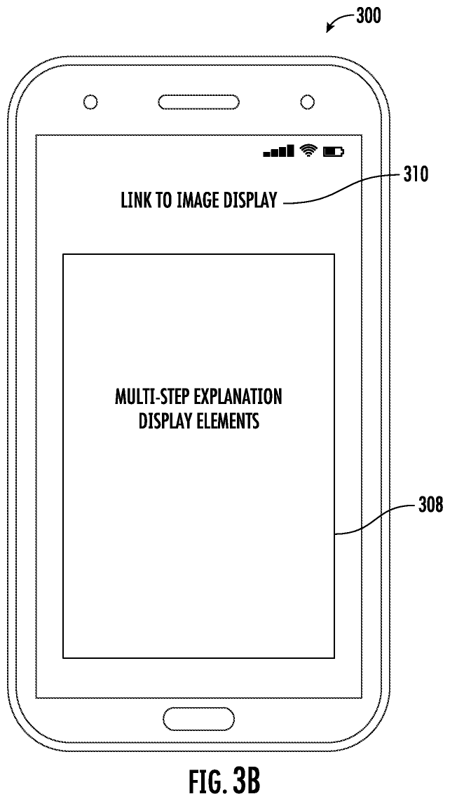

FIG. 3A depicts an example interface for application that presents images captured by a camera of the user computing device and analyzes the contents of the images to provide services to the user in accordance with example embodiments of the present disclosure.

In this example, a user computing device 300 includes a user interface 302 that displays image data (images or video captured by the camera associated with the user computer device 300) to the user. In some examples, the application can determine that there is text within the image 304.

The text within the image 304 can be analyzed by the application to determine the specific content of the text 304. In some examples, the user application can determine that the text includes a pedagogical exercise. In some examples, if the application determines that the one or more images 304 includes a pedagogical exercise, the application can be updated to include explanation request interface element 306.

If the explanation request interface element 306 (e.g., a button in the interface) is selected by the user, the application can use an explanation model to generate a multi-step explanation for the pedagogical exercise. The result of this model can be displayed in the interface as shown in FIG. 3B.

FIG. 3B includes an example interface that can display a multi-step explanation to the user in response to the user requesting that explanation through the explanation request interface element in accordance with example embodiments here. In this example, the interface can be updated to display the multi-step explanation 308. In some examples, each step of the multi-step explanation is displayed in a distinct, collapsible, section. In some examples, the interface can also include a link 310 to return to the image display.

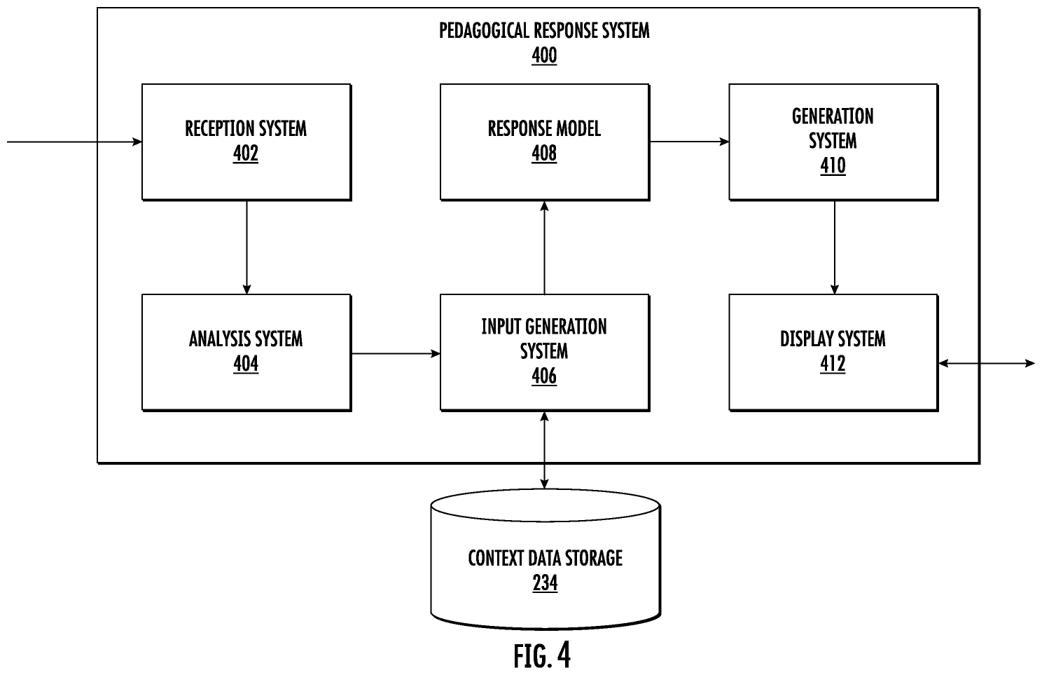

FIG. 4 represents an example system for providing multi-step explanations for solutions to pedagogical exercises according to example embodiments of the present disclosure. The pedagogical response system 400 includes a reception system 402, an analysis system 404, an input generation system 406, a response model 408, a generation system 410, and the display system 412.

The reception system 402 can receive a request or query from a user. The request or query can include a text query, an image query, or an audio input query. In other examples, the request can be determined based on an image in an application that displays image data to the user and analyzes the image data that is on the screen. If the image is determined to include a pedagogical exercise, the interface can be updated to include an interface element that enables the user to request an explanation of the pedagogical interface. Selection of this interface element (e.g., a button) can generate a request to the reception system 402 to provide it with a response to the pedagogical exercise.

The analysis system 404 can analyze the request. In some examples, the request can be received as a general query, without the user specifically indicating that it is a pedagogical exercise. In this case, the analysis system 404 can analyze the request to determine if it includes a pedagogical exercise for which an explanation may be required.

In accordance with the determination, by the analysis system 404, that the request includes a pedagogical exercise, the analysis system 404 can transmit the pedagogical exercise to the input generation system 406. The input generation system 406 can generate an input to the response model 408. For example, the input can be a prompt to a large language model that includes instructions about the type of response to be output by the response model 408.

In some examples, the input generation system 406 can access context data stored in a context data storage 234. The context data can include information about the user submitting the query (with the express permission of the user), information about one or more subjects associated with the pedagogical exercise, information requesting a specific type of output. (e.g., based on the type of display in which the results will be displayed), and any information about requirements or restrictions for the results such as content restrictions.

The input generation system 406 can then generate a prompt that includes, but is not limited to, the pedagogical exercise, any context data from the context data storage 234 and any information about previous interactions with the user (e.g., if this query is part of a multi-query conversation the user is having previous inputs and outputs can be supplied as context as well). The input can be transmitted to the response model 408 (e.g., a machine-learned explanatory model) as input. In response, the response model 408 can generate a structured, multi-step explanation as output. In some examples, the output generated can be text based, image based, or audio based.

In some examples, the output is a multi-step explanation of a solution to the pedagogical exercise. Each step can be displayed in a distinct section of the user interface. In some examples, each section of the user interface can be collapsible. When collapsed, the section associated with each step can include a general summary of the step. When a section is expanded (e.g., a user clicks on an element in the user interface that causes a particular section to expand) a more detailed explanation of how to accomplish that step can be displayed.

In some examples, the output can also include a general summary of the high-level strategy of the multi-step solution, such that the user can understand the context of each step. The high-level strategy can be displayed above the series of steps in the user interface. In some examples, complicated steps may have a series of sub-steps within them. Each sub-step can be displayed in a collapsible section within the parent step. In this way, additional detail can be provided for each step as necessary with a series of nested explanations.

The output of the response model 408 can be transmitted to the generation system 410. The generation system 410 can receive the output of the response model 408 and generate, based on the output, information to be used to display the steps correctly in the user interface. For example, the output of the response model 408 can include formatting data for displaying the steps in the multi-step explanation. In other examples, the generation system 410 can generate the formatting data.

In addition, the output of the response model 408 may include text and instructions to generate additional media such as images and rendered formulas. The generation system 410 can use the instructions from the response model 408 to generate appropriate media. For example, the output of the response model 408 may provide instructions for a particular image to be displayed along with a particular step in the multi-step explanation. The generation system 410 can use instructions generated by the response model 408 to generate an appropriate image and include it in the step for which it is associated. Similarly, the response model 408 can output instructions for rendering a mathematical formula. The generation system 410 can use these instructions to generate the appropriate mathematical formula for a particular step.

Once the generation system 410 has completed generating all needed portions of the multi-step explanation, the portions can be transmitted to the display system 412. The display system can cause the multi-step explanation to be displayed. For example, if the application is running on a user computer device the explanation can be displayed in the appropriate question of the user interface associated with the user computing device. However, if the pedagogical response system 400 is running at a remote server system, the information for displaying the multi-step explanation can be transmitted by the display system to the appropriate requesting device.

FIG. 5 depicts a block diagram of an example computing device 500 that performs according to example embodiments of the present disclosure. The computing device 500 can be a user computing device or a server computing device.

The computing device 500 includes a number of applications (e.g., applications 1 through N). Each application contains its own machine learning library and machine-learned model(s). For example, each application can include a machine-learned model (an explanatory machine-learned model or a synthesis machine-learned model). Example applications include a text messaging application, an email application, a dictation application, a virtual keyboard application, a browser application, search application, a query response application, etc.

As illustrated in FIG. 5, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 6 depicts a block diagram of an example computing device 600 that performs according to example embodiments of the present disclosure. The computing device 600 can be a user computing device or a server computing device.

The computing device 600 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., an explanatory machine-learned model or a synthesis machine-learned model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 600. As illustrated in FIG. 6, the central device data layer can communicate with a number of other components of the computing device, such as, for example, one or more sensors, a context manager, a device state component, and/or additional components. In some implementations, the central device data layer can communicate with each device component using an API (e.g., a private API).

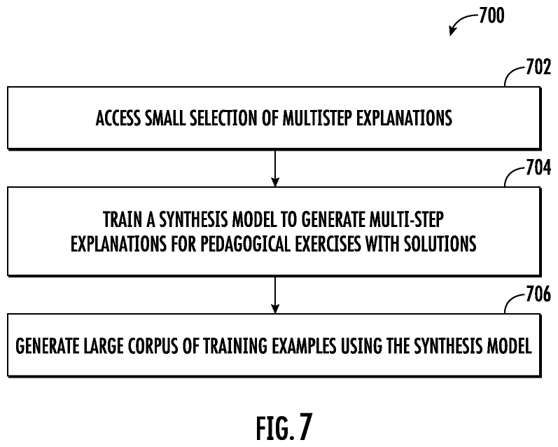

FIG. 7 depicts an example flow diagram for a method of generating additional training data using a synthesis machine-learned model according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1 and 4.

In some examples, a training system can, at 702, access a small corpus of pedagogical exercises with associated multi-step explanations. Each of these examples can be difficult to generate manually and thus only a small number can effectively be created. However, once a small number has been generated, these examples can be used to train a synthesis machine-learned model. The synthesis machine-learned is a machine-learned model that can use existing pedagogical exercises and solution pairs that do not have an associated multi-step explanation to generate a multi-step explanation.

In some examples, the synthesis machine-learned can be trained to take as input a pentagonal exercise and a known solution. The synthesis machine-learned model can, at 704, be trained to generate a satisfactory multi-step explanation for the pedagogical exercise. In this way, a vast corpus of existing pedagogical exercises that have solutions but do not have multi-step explanations can be used to generate a much larger training set for the explanatory machine-learned model.

Once the synthesis machine-learned model is trained, the synthesis machine-learned model can generate, at 706, a large corpus of training examples. Using the synthesis model to generate a large training set for the explanatory machine-learned model significantly reduces the cost and expense of training the explanatory machine-learned model. In this case the explanatory machine-learned model can learn to generate multi-step explanations for pedagogical exercises that do not have solutions.

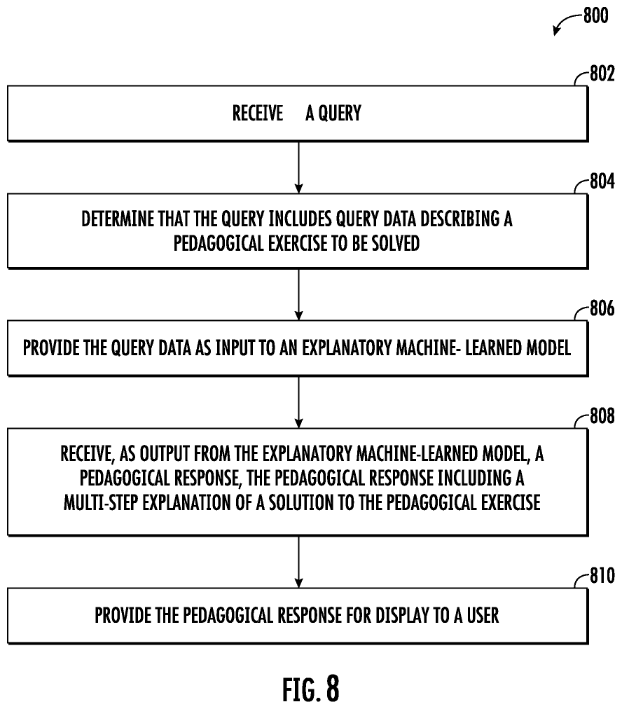

FIG. 8 depicts an example flow diagram for a method of generating multi-step explanation of solutions for pedagogical exercises according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1 and 4.

A computing system (e.g., user computing device 102 in FIG. 1) can include one or more processors, memory, and one or more communication systems. The one or more communication systems allow the computing system to transmit data to other computing systems via a communication network, sensors can include a camera, one or more motion sensors, one or more proximity sensors, and so on. The user computing device 102 (e.g., user computing device 102 in FIG. 1) can include other components that, together, enable the user computing device 102 (e.g., user computing device 102 in FIG. 1) to generate (or receive) a multi-step explanation of a solution to a pedagogical exercise.

The computing system can receive, at 802, a query. The query can be submitted as text through a search or query service. For example, a user can access an application or visit a website that allows users to enter queries in a text field. In another example, an application can display and analyze the contents of images (either single frame images or video content currently being captured by the camera of the device). The application can be designed such that displayed images can be analyzed and queries can be automatically generated based on that content. In general, queries can include one or more of: text data, image data, and audio data.

In some examples, the computing system can determine, at 804, that query includes query data describing a pedagogical exercise to be solved. For example, the query can be parsed to determine its content. In some examples, determining that the query includes query data describing a pedagogical exercise to be solved can include determining that a query type associated with the query is an explanation query type. In some examples, other query types can be search queries, location queries, social queries, summary queries, and so on. Once the computing system determines that the query is an explanation query (e.g., a query requesting an explanation that can be classified as having the type “explanation”), the computing system can extract data describing the pedagogical exercise to be solved from the query.

In some examples, the computing system can, at 806, provide the query data as input to an explanatory machine-learned model. In some examples, the explanatory machine-learned model is a large language model. In some examples, providing the credit as input can involve generating a prompt for the explanatory machine-learned model. A prompt can include information associated with the query and other contextual information that may be useful in providing the best explanation possible. For example, the prompt will include information describing the context of the query such as previous portions of a discussion with the user, information about the user the user has provided and agreed to be allowed for use in generating explanations, and information about the topic for which the pedagogical exercise is associated.

For example, a query response system can store information on a variety of topics that may be relevant to explanation queries. For example, specific subjects such as math or physics may have a database of corresponding information that is available to the query response system. When a query of type explanation is received the system may access stored information for the particular subject relevant to the query and provide information to the machine-learned model to add context for the prompt. Similarly, information that's stored in the user profile describing the user's current understanding of the topic or educational level may be provided, with user permission to the machine-learned model to ensure that the provided explanation is appropriate for the requesting user.

In some examples, the prompt can also include instructions for the explanatory machine-learned model, the instructions indicating one or more constraints in the output produced by the explanatory machine-learned model. In some examples, the constraints ensure that inappropriate content is not presented in the response. In other examples, the constraints can indicate whether the final solution to the pedagogical exercise should be included or should be left for the user to complete based on the instructions.

In some examples, the computing system can receive, at 808, as output from the explanatory machine-learned model, a pedagogical response, the pedagogical response including a multi-step explanation of a solution to the pedagogical exercise. In some examples, the output of the explanatory machine-learned model includes formatting data for use in displaying the pedagogical response. The formatting data can include markup data.

In some examples, the formatting data can cause each step in the multi-step explanation to be displayed in a distinct section of a user interface. Each distinct section of the user interface can collapse such that one or more steps in the multi-step explanation can be hidden or displayed in a simplified form. In some examples, the output generated by the explanatory machine-learned model can designate, for a respective step in the explanatory machine-learned model, whether the respective step should initially be displayed as collapsed or expanded. In some examples, the explanatory machine-learned model determines that the respective step is collapsed or expanded based on the user's current level of understanding.

In some examples, the computing system can, at 810, provide the pedagogical response for display to a user. For example, the pedagogical response can be transmitted to a user computing device to be displayed in an interface associated with an application (e.g., a web browser application or a query application) on the user computing device.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
receiving a query from a user;
determining that the query includes query data describing a pedagogical exercise to be solved;
providing the query data as input to an explanatory machine-learned model;
receiving, as output from the explanatory machine-learned model, a pedagogical response, the pedagogical response including a multi-step explanation of a solution to the pedagogical exercise; and
providing the pedagogical response for display to a user.

2. The system of claim 1, wherein the query data includes one or more of: text data, image data, and audio data.

3. The system of claim 1, wherein determining that the query includes query data describing a pedagogical exercise to be solved comprises:
determining that a query type associated with the query is an explanation query type; and
extracting data describing the pedagogical exercise to be solved from the query.

4. The system of claim 1, wherein the explanatory machine-learned model is a large language model.

5. The system of claim 1, wherein the output of the explanatory machine-learned model includes formatting data for use in displaying the pedagogical response.

6. The system of claim 5, wherein the formatting data includes markup data.

7. The system of claim 5, wherein the formatting data causes each step in the multi-step explanation to be displayed in a distinct section of a user interface.

8. The system of claim 7, wherein each distinct section of the user interface is collapsible such that one or more steps in the multi-step explanation can be hidden.

9. The system of claim 1, wherein providing the query data as input to the explanatory machine-learned model further comprises:
generating a machine-learned model prompt, wherein the prompt includes the query data, context information for the query data, and instructions to the machine-learned model.

10. The system of claim 9, wherein the contextual information includes user profile data describing a user current level of understanding.

11. The system of claim 10, wherein the output generated by the explanatory machine-learned model designates, for a respective step in the multi-step explanation, whether the respective step should initially be displayed as collapsed or expanded.

12. The system of claim 11, wherein the output of the explanatory machine-learned model designates whether the respective step is collapsed or expanded based on the user's current level of understanding.

13. A computer-implemented method, the method comprising:
receiving, by a computing system comprising one or more processors, an image that includes a pedagogical exercise;
extracting, by the computing system, data describing the pedagogical exercise;
providing, by the computing system, the data describing the pedagogical exercise as input to an explanatory machine-learned model;
receiving, as output from the explanatory machine-learned model, a pedagogical response, the pedagogical response including a multi-step explanation of the solution to the pedagogical exercise; and
providing the pedagogical response for display to a user.

14. The computer-implemented method of claim 13, wherein the explanatory machine-learned model is a large language model.

15. The computer-implemented method of claim 13, wherein providing the pedagogical response for display to a user further comprises:
providing the multi-step explanation in a format such that each respective step can be displayed in a respective collapsible section of the user interface.

16. The computer-implemented method of claim 15, wherein a respective step in the multi-step process includes one or more of text, images, and rendered mathematical formulas.

17. The computer-implemented method of claim 16, wherein rendered mathematical formulas are rendered based on rendering data output by the machine-learned model.

18. The computer-implemented method of claim 16, wherein images can be generated based on a description of the characteristics of an image output by the machine-learned model.

19. The computer-implemented method of claim 13, wherein the input to the explanatory machine-learned model can be multimodal.

20. One or more non-transitory computer-readable media that collectively store instructions that, when executed by one or more computing devices, cause the one or more computing devices to perform operations, the operations comprising:
obtaining first training data for a large language model, wherein the training data includes a plurality of example pedagogical exercises, the solutions to those exercises, and ground truth multi-step explanations for the solutions;
providing the pedagogical exercises and the solutions to those exercises as input to a synthesis machine-learned model;
receiving, as output from the synthesis machine-learned model, a first plurality of multi-step solutions for pedagogical exercises;
comparing evaluating the plurality of multi-step solutions to the ground truth multi-step explanations and updating one or more characteristics of the synthesis machine-learned model based on the comparison until the plurality of multi-step solutions meet one or more criteria of acceptability;
obtaining second training data, wherein the second training data includes a plurality of example pedagogical exercises and the solutions to those exercises without multi-step explanations;
providing the second training data as input to the synthesis machine-learned model;
receiving, as output from the synthesis machine-learned model, a second plurality of multi-step solutions for the pedagogical exercises included in the second training data;
training an explanatory machine-learned model using the second training data and the second plurality of multi-step solutions generated by the synthesis machine-learned model.
